(19) United States
(12) Patent Application Publication
(10) Pub. No.: US 2007/0242813 A1
(43) Pub. Date: Oct. 18, 2007

(54) Electronic Conference System, Electronic Conference Support Method, And Electronic Conference Control Apparatus

(75) Inventors: Kazunori Horikiri, Kanagawa (JP); Yoshiki Watanabe, Kanagawa (JP); Masatomi Inagaki, Tokyo (JP); Yoshihiro Masuda, Ashigarakami-gun (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/557,996

(22) Filed: Nov. 9, 2006

(30) Foreign Application Priority Data
Apr. 14, 2006 (JP) 2006-111496

(51) Int. Cl. H04M 11/00

(52) U.S. Cl. 379/93.21

(57) ABSTRACT

An electronic conference system includes a portable storage device that stores written content as image data, a reader that reads the image data recorded in the portable storage device, and a display controller that incorporates the image data read by the reader as additional image data into image data to be displayed on a display device and displays the image data incorporating the additional image data.

### BACKGROUND

1. Technical Field

The present invention relates to an electronic conference system, an electronic conference support method, and an electronic conference control apparatus.

2. Related Art

Conventionally, there have been electronic conference systems equipped with a displayable and writable large touch panel display device. The touch panel display device is typically placed at a location that is visible to all conference participants present in a conference room and is also writable for the conference participants. In addition to giving conference participants an opportunity to participate in a conference while sitting in their own chairs, utilization of such an electronic conference system also enables a conference style that conference participants to gather around a touch panel display device and conduct a discussion while writing ideas conceived during the conference onto the touch panel display device. The content written on the touch panel display device can be stored as a screen image on an “as is” basis, which can bring efficiency to conferences. As a result, there has been a trend toward more and more companies adopting an electronic conference system, by virtue of efficiency in conducting conferences.

Meanwhile, a KJ method is known as a creative problem-solving technique used for drawing a solution to a problem during a discussion or the like. In the KJ method, each person is requested to offer, at an early stage, ideas which might give a clue towards a solution or might lead directly to a solution. Even when the KJ method is utilized in an electronic conference, no changes are made in the basic work flow of the KJ method, and it is an effective approach that ideas having been conceived by each member prior to participating in a meeting are collected at the meeting before starting a discussion and used for deriving the solution to a problem.

Conventionally, sharing of ideas brought in by each member with other members has required that the ideas be individually noted on paper or written as electronic data in advance, and collected together for use in a discussion.

### SUMMARY

In an aspect of the present invention, an electronic conference system comprises a display apparatus, a portable storage device in which contents of a written note are recorded as image data, a reader that reads the image data recorded in the portable storage device, and a display controller that incorporates the image data read by the reader into image data to be displayed on the display apparatus as additional image data for displaying the image data incorporating the additional image data.

### BRIEF DESCRIPTION OF THE DRAWINGS

Exemplary embodiments of the present invention will be described in detail by reference to the following figures, wherein:

FIG. 1 is a block configuration diagram showing an electronic conference system according to an exemplary embodiment of the present invention;

FIG. 2A illustrates a user scene for using the electronic conference system according to the exemplary embodiment;

FIG. 2B illustrates a user scene for using the electronic conference system according to the exemplary embodiment;

FIG. 2C illustrates a user scene for using the electronic conference system according to the exemplary embodiment;

FIG. 3 is a communication sequence diagram showing a transfer procedure for transferring note image data and other data from a portable terminal device on the basis of a token generated by the portable terminal device in the exemplary embodiment; and

FIG. 4 is a communication sequence diagram showing another transfer procedure for transferring note image data and other data from the portable terminal device on the basis of a token generated by a conference control apparatus in the exemplary embodiment.

### DETAILED DESCRIPTION

By reference to the drawings, exemplary embodiments of the present invention will be described below.

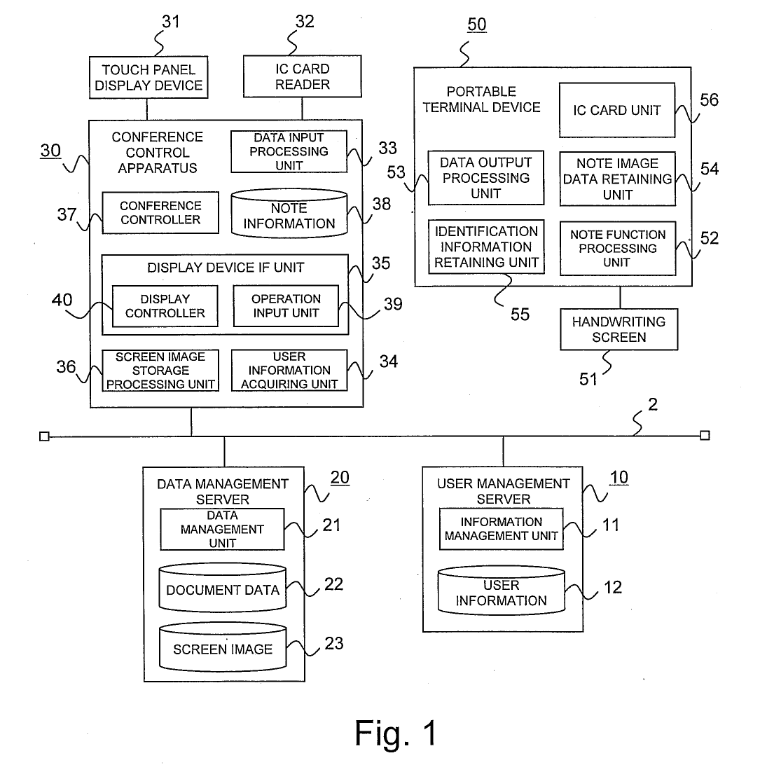

FIG. 1 is a block configuration diagram showing an electronic conference system according to an exemplary embodiment of the present invention. FIG. 1 shows a user management server 10, a data management server 20, and a conference control apparatus 30 respectively connected to a LAN 2, which is one form of network, in addition to a portable terminal device 50 carried by a conference participant. Although the portable terminal device 50 is provided in a number equal to the conference participants, because the portable terminal devices 50 are individually carried by the conference participants, all the portable terminal devices 50 may have the same configuration, and only one of the portable terminal devices 50 is shown in FIG. 1.

The user management server 10 is a server computer which retains and manages information regarding each user who participates in an electronic conference. The user management server 10 includes a user information storage unit 12 in which is stored information including necessary information for user authentication, user IDs, card IDs of IC cards that users possess, and storage destinations of screen images owned by the users. In response to a request from the conference control apparatus 30, an information management unit 11 reads user information from the user information storage unit 12, updates user information, and performs management and processing of information regarding the users such as user authentication information. The information management unit 11 is implemented by collaborative operation of a computer forming the user management server 10 and a program running on a CPU mounted in the computer. Meanwhile, the user information storage unit 12 is implemented by an external storage device mounted in the user management server 10.

The data management server 20 is a database server computer which retains and manages image data to be used in electronic conferences. The data management server 20 includes a document data storage unit 22 storing document data, such as conference materials converted into an electronic form used in electronic conferences, to be displayed on a touch panel display device 31. Meanwhile, screen images displayed on the touch panel display device 31 are stored in a screen image storage unit 23. In response to a request from the conference control apparatus 30, a data management unit 21 performs information management, such as registration of image data in the document data storage unit 22, readout of image data from the document data storage unit 22, and registration of screen images sent from the conference control apparatus 30. The data management unit 21 is implemented by collaborative operation of a computer forming the data management server 20 and a program running on a CPU mounted in the computer. Meanwhile, the document data storage unit 22 and the screen image storage unit 23 are implemented by external storage devices mounted in the data management server 20.

The conference control apparatus 30, which is a client computer used for controlling a conference, is connected to peripheral devices of the touch panel display device 31 and an IC card reader 32. The touch panel display device 31 is disposed in the manner of an electronic white board so as to provide all participants with viewability to content displayed thereon, and displays conference materials or the like used for electronic conferences. The IC card reader 32, which is typically a device for reading IC cards owned by conference participants in order to authenticate users participating in the conference, is also used as a reader for reading data stored in the portable terminal devices 50 carried by the users in this exemplary embodiment. Although in the present exemplary embodiment the IC card reader 32 is placed beside the touch panel display device 31 or integrated into the touch panel display device 31, the IC card reader 32 may be placed at any location.

The conference control apparatus 30 has a data input processing unit 33, a user information acquiring unit 34, a display device interface (IF) unit 35, a screen image storage processing unit 36, a conference controller 37, and an annotation information storage unit 38. The data input processing unit 33 obtains data read by the IC card reader 32 and writes the data as annotation information into the annotation information storage unit 38. The user information acquiring unit 34 acquires information regarding the users, such as names of the conference participants, through a query issued to the user management server 10. The display device IF unit 35 controls operation of the touch panel display device 31. An operation input unit 39 contained in the display device IF unit 35 detects user operation performed on the touch panel display device 31 and accepts an input by the user operation and an input of note data or the like. Further, the display controller 40 controls display on the touch panel display device 31, such as displaying of image data registered in the data management server 20 and the annotation information written in the annotation information storage unit 38. The screen image storage processing unit 36 transmits a screen image displayed on the touch panel display device 31 to the data management server 20 for storing the screen image. The conference controller 37 controls operation of the units 33 to 36 other than the conference controller 37 itself and performs overall control of an electronic conference in cooperation with other computers. The units 33 to 37 in the conference control apparatus 30 are implemented by collaborative operation of a computer forming the conference control apparatus 30 and a program running on a CPU mounted in the computer. Meanwhile, the annotation information storage unit 38 is implemented by an external storage device mounted in the conference control apparatus 30.

The portable terminal device 50 is an information device of a mobile type that the conference participants carry and bring in a conference room. In the present exemplary embodiment, the portable terminal device 50 is assumed to be a personal digital assistant (PDA) which also functions as a handwriting screen 51 on which writing can be performed through a liquid crystal screen display using a pen, for example. The portable terminal device 50 has a note function processing unit 52, a data output processing unit 53, a note image data retaining unit 54, an identification information retaining unit 55, and an IC card unit 56. The note function processing unit 52 causes the handwriting screen 51 to accept handwriting by means of an electronic pen or the like, and writes a displayed image on the display (written content) in the note image data retaining unit 54 for storing the displayed image according to a storage operation performed by a person who has input the handwriting. The identification information retaining unit 55 retains IP addresses as information necessary for identifying the portable terminal devices 50 and for inter-device communication and retains user IDs as information used for identifying owners of the portable terminal devices 50. In the present exemplary embodiment, short-range wireless communication is established between the IC card reader 32 and the portable terminal device 50, and the IC card unit 56 functions as a storage area retaining data to be read by bringing the IC card reader 32 in proximity with the portable terminal device 50. The data output processing unit 53 outputs data via the IC card reader 32 to the data input processing unit 33. The units 52 to 53 in the portable terminal device 50 are implemented by collaborative operation of a computer mounted in the portable terminal device 50 and a program running on a CPU mounted in the computer. The units 54 to 56 may be implemented by a nonvolatile memory such as a flash memory.

As can be seen from the above-described system configuration, the electronic conference system according to the present invention is not necessarily limited to application in teleconferences which take place using remote connections of distant sites, and may be applied to conferences which are conducted using the touch panel display device 31 and various computers connected to a network.

Conventional electronic conference systems fit, as described above, a conference style in which participants in a conference gather around a touch panel display device and hold discussions while writing remarks or other items produced during the conference on the touch panel display device. Meanwhile, no proposed technique is convenient and efficient for a conference style in which individual ideas created by each participant are collected for the sharing of the ideas among the participants, and discussions are held using the shared ideas.

Described below is operation of importing ideas produced by conference participants in the touch panel display device 31 using the portable terminal device 50 to share the ideas among the conference participants in the electronic conference system according to the present exemplary embodiment.

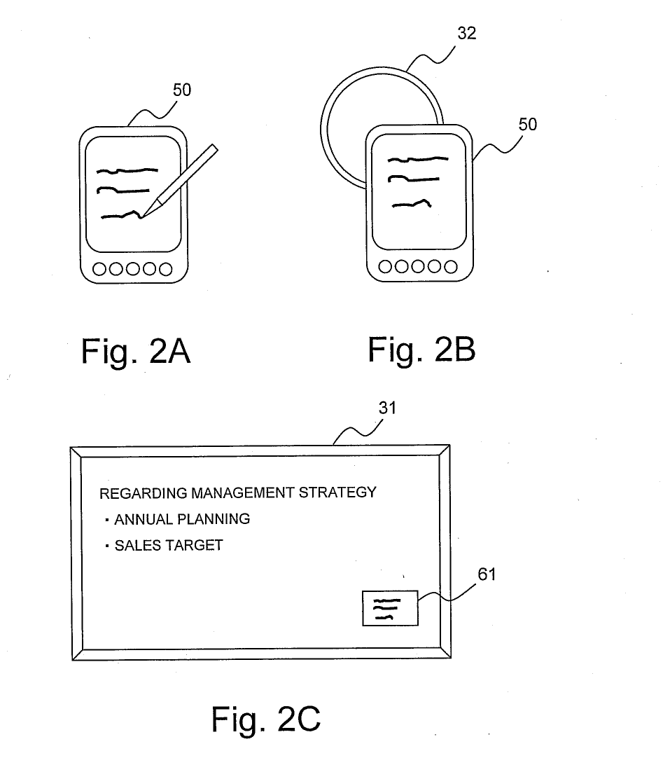

First, brief description of user scenes employing the present exemplary embodiment is provided with reference to FIGS. 2A to 2C.

A conference participant writes into the portable terminal device 50 a note on an idea that the conference participant has personally conceived during a conference (FIG. 2A). As described above, the portable terminal device 50 may be equipped with a note function which enables handwriting on a display by means of an electronic pen or the like. After storing the note in the portable terminal device 50, the conference participant moves to the IC card reader 32 situated in the vicinity of the touch panel display device 31 and inputs a predetermined transfer operation. Upon completion of the input, the conference participant brings the portable terminal device 50 into proximity with the IC card reader 32 (FIG. 2B), which causes the IC card reader 32 to read data from the portable terminal device 50 via short-range wireless communication. After the data is read by the IC card reader 32, the conference control apparatus 30 generates annotation information from the read data, and displays the annotation information as an electronic annotation 61 on the touch panel display device 31 (FIG. 2C). In this manner, the data written into the portable terminal device 50 is displayed on a screen in a form which gives the appearance that an annotation is stuck on the screen. The conference participants can touch a display position of the annotation 61 with their fingers on the touch panel display device 31 and move their fingers while touching the annotation 61 in order to relocate the display position of the annotation 61.

Next will be described processing steps for displaying the data written into the portable terminal device 50 as an annotation on the touch panel display device 31.

When the conference participant performs a predetermined storage operation subsequent to the writing of an idea or a note on the handwriting screen 51 by means of the note function of the portable terminal device 50, the note function processing unit 52 records the content of the idea or note written on the handwriting screen 51 into the note image data retaining unit 54 as note image data, in association with property information including time of writing at which data is stored in accordance with the predetermined storage operation, attributes, and other features of the data. Subsequently, when the conference participant issues a request for data transfer by executing a predetermined operation, the data output processing unit 53 generates a new token, associates the new token with the data retained in the note image data retaining unit 54 and the user ID retained in the identification information retaining unit 55, and records the IP address and the token in the IC card unit 56.

Next, when the conference participant brings the portable terminal device 50 into proximity with the IC card reader 32 and holds it over the IC card reader 32, the data output processing unit 53 of the portable terminal device 50 and the data input processing unit 33 of the conference control apparatus 30 cooperate to transfer the data stored in the portable terminal device 50 from the portable terminal device 50 to the conference control apparatus 30. Processing steps of this data transfer will be described below.

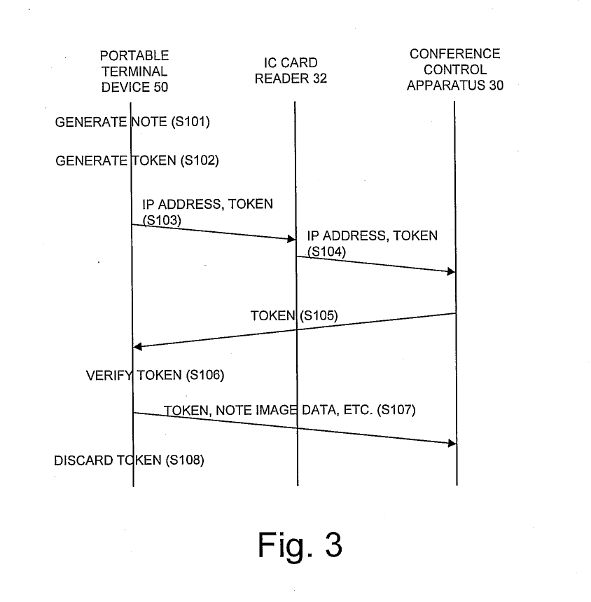

As a technique for transferring the note image data and other data from the portable terminal device 50 to the conference control apparatus 30, a transfer method using a token generated by the portable terminal device 50 and a transfer method using a token generated by the conference control apparatus 30 can be conceived. A transfer procedure for performing a transfer using the token generated by the portable terminal device 50 will be described first, by reference to the communication sequence diagram shown in FIG. 3.

In the portable terminal device 50, a note is generated (step 101), and a token is generated and recorded in the IC card unit 56 (step 102) as described above. Thereafter, when a user holds the portable terminal device 50 over the IC card reader 32, the IC card reader 32 reads data; i.e. the token and the IP address, stored in the IC card unit 56 (step 103), while the data input processing unit 33 inputs the read data (step 104). Further, the data input processing unit 33 specifies the input IP address to establish a connection with the portable terminal device 50 via a wireless communication network, and provides the input token to thereby send a data transmission request to the portable terminal device 50 (step 105). The data output processing unit 53 checks the provided token to determine whether or not the provided token is the valid token generated in the portable terminal device 50. When validity of the provided token is verified (step 106), the data output processing unit 53 transmits to the data input processing unit 33 the note image data stored in the note image data retaining unit 54 associated with the token and the user ID registered in the identification information retaining unit 55 (step 107). On the other hand, when the provided token is invalid, the data output processing unit 53 ignores or refuses the data transmission request, and the data transmission request is abandoned (step 108).

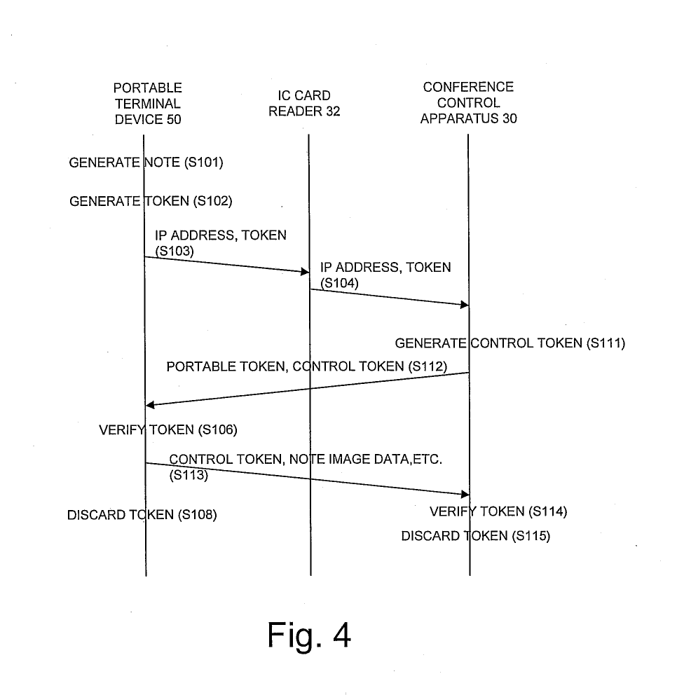

Next, by reference to the communication sequence diagram shown in FIG. 4, another transfer procedure for performing transfer using the token generated by the conference control apparatus 30 will be described.

In the portable terminal device 50, a note is generated (step 101), and a token is generated and written in the IC card unit 56 (step 102). Thereafter, when a user holds the portable terminal device 50 over the IC card reader 32, the IC card reader 32 reads data; i.e., the token and the IP address, stored in the IC card unit 56 (step 103), while the data input processing unit 33 inputs the read data (step 104). Up to this point, processing steps are identical with those performed in a case of transferring the note image data and other data on the basis of the token of the portable terminal device 50 as designated by reference numerals identical with those used in the case of the token of the portable terminal device 50. Then, after generating a new token used for accessing the portable terminal device 50 (step 111), the data input processing unit 33 designates the input IP address to establish a connection with the portable terminal device 50 via the wireless communication network. Next, the data input processing unit 33 provides the token having been input (hereinafter referred to as a “portable token”) along with the token that the data input processing unit 33 has generated by itself (hereinafter referred to as a “control token”) to thereby send a data transmission request via the IC card reader 32 to the portable terminal device 50 (step 112). The data output processing unit 53 checks the provided portable token to determine whether or not the provided portable token is the valid token that the data output processing unit 53 has generated itself. Upon the verification of the provided portable token (step 106), the data output processing unit 53 retrieves the note image data and other data items associated with the provided portable token in addition to the user ID, and sends the retrieved data to the data input processing unit 33 along with the provided control token (step 113). On the other hand, when the provided token is invalid, the received data transmission request is ignored or refused, and abandoned (step 108). Further, the data input processing unit 33 checks the provided control token to determine whether the provided control token is the valid token that the data input processing unit 33 has generated itself. When validity of the provided control token is verified (step 114), the data input processing unit 33 abandons the control token after extracting the note image data and other data associated with the control token (step 115).

Alternatively, when the user holds the portable terminal device 50 over the IC card reader 32, the IC card reader 32 may read the IP address of the portable terminal device 50, while the conference control apparatus 30 may generate the control token on the basis of the read IP address and send the generated control token and the IP address of the conference control apparatus 30 to the portable terminal device 50. In other words, data may be transferred without use of the portable token.

The conference participants can be identified with a certain degree of precision, whereas the portable terminal devices 50 to be connected by means of wireless access are not specifically identified. With this in view, data is transmitted by means of the token generated by the portable terminal device 50 or the conference control apparatus 30, thereby realizing data transfer which is secure to a certain extent and enabling stable transfer control.

When the data retained in the portable terminal device 50 is imported into the conference control apparatus 30 through the above-described data transfer processing, the data input processing unit 33 registers the data in the note information storage unit 38. The annotation information to be registered is composed of a transfer time at which the data is transmitted and attribute information including display position information, a display size, display colors, and other features on the screen added to the various transmitted data items. Although in the above description the importing of only single annotation into the conference control apparatus 30 is exemplified, transfer of note image data may be repeated to thereby enable importing and storing of multiple annotations in a single connection step.

When new annotation information is registered in the annotation information storage unit 38, the conference controller 37 issues a request to the display device IF unit 35 for displaying the annotation on the screen. More specifically, the display controller 40 in the display device IF unit 35 reads the newly registered annotation information from the annotation information storage unit 38, generates annotation image data from the annotation information, merges the generated annotation image data with the image data being presently displayed to thereby generate an screen image, and displays the screen image on the touch panel display device 31. Although, in actuality, the annotation image data is generated and merged on the basis of the annotation information and displayed on the touch panel display device 31 as described above, for simplicity of explanation, these processing steps are collectively expressed by the description “the annotation is displayed” or “to affix the annotation,” similar to that used with respect to an annotation being a paper medium. After displaying the annotation, the display controller 40 updates display attribute information of the displayed annotation registered in the annotation information storing unit 38.

Although there are cases, of course, where multiple annotations are merged in the same screen image to be displayed on the touch panel display device 31, the sizes of the annotations are basically set to the same dimensions. Because the portable terminal devices 50 individually used by the conference participants are basically of the same model having the handwriting screens 51 of the same size, it is conceivable that the note image data to be generated will have the same size. However, variations in size of the note image data can be expected, for example, in a case where different models of the portable terminal devices 50 are used. In this case, a character size may be reduced (contraction of note image data), or the display size of annotations may be reduced to accommodate the variations. In addition, the display size may be scaled up or down through a predetermined user operation.

The display controller 40 displays the annotation at an appropriate position which is defined as the display position according to predetermined conventions. When multiple annotations are displayed on the same screen image, display of the multiple annotations is performed while shifting the multiple annotations to prevent overlap of annotations. The conference participants can move their fingers while contacting the display position of an annotation with their fingers to relocate the display position of the annotation as described above. It can be said that this operation of the conference participants corresponds to a drag operation using a finger instead of a mouse. After comparing display position information of the annotation with a contact location of the finger to find a positional relationship, the operation input unit 39 can recognize the drag operation of users from the positional relationship. Meanwhile, the display controller 40 can move and display the corresponding annotation on the screen in accordance with the drag operation.

Naturally, it is assumed for the touch panel display device 31 that annotations corresponding to multiple conference participants will be displayed on the same screen image. In an exemplary embodiment, the user IDs may be imported in addition to the note image data from the portable terminal devices 50, and the annotations may be displayed with the user IDs associated with the annotations. Alternatively, the user information acquiring unit 34 may acquire user names corresponding to the user IDs, and the user names may be associated with the annotations.

Although the annotations may be displayed with the same color, display colors of the annotations may be changed for each user ID in light of the presence of the multiple user IDs which are imported from the portable terminal device 50 along with the note image data in this exemplary embodiment. Because the display colors are changed in view of identification of conference participants who have affixed the annotations in this exemplary embodiment, the display controller 40 can select display colors as appropriate, or the conference participants may be allowed to specify colors by retrieving display color information from the portable terminal device 50. Alternatively, the display color information may be predefined in the user information managed by the user management server 10, and may be retrieved from the user management server 10 at the time of display.

Further, because the annotations are image data constituting a part of the screen image, users can perform write operations or other operations on the annotations. Still further, the content written down in the annotation may be rendered as textual information through analysis of the content using a character recognition function, which enables text editing of the content.

In this manner, the ideas individually conceived by the conference participants can be imported into the conference control apparatus 30 and shared among the conference participants by merely bringing the portable terminal device 50 into proximity with the IC card reader 32. The conference participants can hold a discussion while referencing the shared content of the notes individually written by the conference participants. When a predetermined user operation is performed or when a predetermined time has elapsed, the screen image storage processing unit 36 sends the displayed screen image through the LAN 2 to the data management server 20 to store the displayed screen image in the screen image storage unit 23.

In the above-described configuration of the system according to the present exemplary embodiment, the ideas individually conceived by conference participants can be imported in the conference control apparatus 30 and displayed on the touch panel display device 31. However, the system is not limited to the above-described configuration. For example, wiring connection may be established between the conference control apparatus 30 and the portable terminal device 50 with an additional effort of coupling cables. Although in the above-described embodiment PDAs are used as the portable terminals 50, the portable terminals 50 may be implemented using electronic paper.

Although in the above described exemplary embodiment the assumed usage pattern is a user scene in which the conference participants present their own ideas individually conceived in the conference room to thereby share the ideas with other participants, the present invention may, of course, be applied to a usage pattern in which the portable terminal devices 50 that prestore the ideas individually conceived by the conference participants are brought into the conference room.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An electronic conference system comprising:
a display apparatus;
a portable storage device in which written content is recorded as image data;
a reader that reads the image data recorded in the portable storage device; and
a display controller that incorporates the image data read by the reader as additional image data into image data to be displayed on the display apparatus.

2. An electronic conference control apparatus in an electronic conference system, comprising:
a display apparatus;
a reader that reads image data recorded in a portable storage device; and
a display controller that incorporates the image data read by the reader as additional image data into image data displayed on the display apparatus to thereby display the image data incorporating the additional image data.

3. The electronic conference control apparatus according to claim 2, wherein the reader further reads user identification information for identifying a user along with the image data recorded in the portable storage device, and the display controller references the user identification information to change a display attribute of the additional image data for each user and displays the image data incorporating the additional image data whose display attributes vary from user to user.

4. The electronic conference control apparatus according to claim 2, wherein the display controller relocates a display position of the additional image data in accordance with a request for moving the additional image data displayed on the display apparatus.

5. The electronic conference control apparatus according to claim 2, further comprising
an operation detector that detects an operation for moving the annotation image data displayed on the display device, wherein
the display apparatus is a touch panel display device capable of detecting physical contact of a user with a display screen, and
the display controller shifts the display position of the additional image data in accordance with the operation detected by the operation detector.

6. The electronic conference control apparatus according to claim 2, wherein the reader transmits and receives data to and from the portable storage device by means of a token generated by the reader or the portable storage device.

7. The electronic conference control apparatus according to claim 2, wherein the reader comprises a sensor unit that reads image data from the portable storage device on a non-contact basis via short-rage wireless communication.

8. A computer readable recording medium storing a program causing a computer contained in an electronic conference system having a display apparatus to execute a process comprising:
inputting image data recorded in a portable storage device; and
incorporating the input image data as additional image data into image data to be displayed on the display apparatus for displaying the image data incorporating the additional image data.

9. An electronic conference supporting method executed by a computer contained in an electronic conference system having a display apparatus, the method comprising:
reading out image data recorded in a portable storage device;
generating additional image data from the read image data; and
merging the generated additional image data with image data to be displayed on the display apparatus for displaying the merged image data.

10. A computer data signal embodied in a carrier wave for enabling a computer contained in an electronic conference system having a display apparatus to perform a process, comprising:
inputting image data recorded in a portable storage device, and
incorporating the input image data as additional image data into image data to be displayed on the display apparatus for displaying the image data incorporating the additional image data.
